(19) United States
(12) Patent Application Publication
(10) Pub. No.: US 2019/0034975 A1
(43) Pub. Date: Jan. 31, 2019

(54) SYSTEMS AND METHODS FOR PROVIDING NON-DISRUPTIVE IN-GAME ADVERTISING AND IDENTIFYING TARGET KNOWLEDGE

(71) Applicant: Smarty Pants LLC dba International Knowledge League, Westlake, OH (US)

(72) Inventors: Wisam RIZK, Westlake, OH (US); Miriam RIZK, Westlake, OH (US); Steven ENGLANDER, Woodmere, NY (US)

(21) Appl. No.: 15/659,266

(22) Filed: Jul. 25, 2017

(51) Int. Cl. G06Q 30/02; G07F 17/32; G06F 3/0482; G06F 17/30

(52) U.S. Cl. CPC G06Q 30/0271; G07F 17/3255; G06F 17/30035; G06F 3/0482; G06Q 30/0218

(57) ABSTRACT

Systems and methods provide advertising or sponsored content in a game environment, and further provide identification of target knowledge scores related to topics for targeting and serving advertising or sponsored content.

### TECHNICAL FIELD

The disclosure relates to advertising and sponsored content, and more particularly to providing advertising or sponsored content non-disruptively which can be targeted to users according to knowledge levels.

### BACKGROUND

A wide variety of online advertising techniques exist today. However, they have several drawbacks. Many are disruptive and distract from or “cheapen” other content. Some are blocked by advertisement blocking software, which has given rise to an escalating race of workarounds and paywalls. Many also have exceedingly low engagement or return on investment. Finally, while advertisements may be targeted using cookies and other techniques, there is no manner for detecting the presence or absence of user knowledge on a topic (or topics) of interest to an advertiser (or the amount of knowledge where present).

These issues are accentuated in game environments. When advertisements are presented during gameplay, they can distract from a user's efforts, wasting time or causing errors. Advertisements of this nature can also be costly to advertisers. Screen real estate is valuable during gameplay. Advertisements between periods of gameplay slow the game and are likely to be ignored.

It would therefore be beneficial to develop systems and methods which integrate advertising in a non-disruptive manner, maintain user attention, and possess the ability to develop an advertiser's understanding of user knowledge and target advertisements based thereon.

### SUMMARY

In an embodiment, a method comprises receiving advertisement data from an advertiser. A gameplay advertisement is based on the advertisement data. The method also comprises entering the gameplay advertisement into an advertisement question store of a question data store. The question data store also includes a game question store. The method also comprises providing gameplay questions from the question store. The gameplay questions include game questions from the game question store and the gameplay advertisement is among the gameplay questions. The method also comprises receiving gameplay responses from a player. A gameplay advertisement response is among the gameplay responses and the gameplay advertisement response indicates knowledge of the player with respect to an advertiser-selected topic. The method also comprises storing the gameplay responses from the player in a gameplay response store. The gameplay response store is within a user data store.

In an embodiment, a method comprises receiving advertisement data from an advertiser. A gameplay advertisement is based on the advertisement data and the advertisement data includes a target knowledge score. The method also comprises storing the gameplay advertisement in a question database, interrogating a user data store to identify one or more users to receive the gameplay advertisement based on the target knowledge score, and providing the gameplay advertisement to the one or more users.

In an embodiment, a system comprises an advertising subsystem configured to receive offers for advertisements from advertiser systems. The advertising subsystem receives advertisement data related to accepted offers for advertisements. The system also comprises an advertisement targeting module of the advertising subsystem configured to receive target knowledge information associated with the advertisement data and a user data store of a data management platform configured to store user data including user knowledge information associated with one or more users. The system also comprises a game data store of the data management platform configured to provide question-based gameplay including the advertisement data to the one or more users and a question data store of the data management platform including gameplay questions. The gameplay questions include gameplay advertisements based on the advertisement data and the gameplay advertisements are provided to the one or more users based on the target knowledge information and the knowledge information.

Additional and alternative aspects will be apparent on review of other portions of this disclosure.

### BRIEF DESCRIPTION

So that those having ordinary skill in the art, to which the present disclosure pertains, will more readily understand how to employ the novel system and methods of the present disclosure, certain illustrated embodiments thereof will be described in detail herein-below with reference to the drawings, wherein:

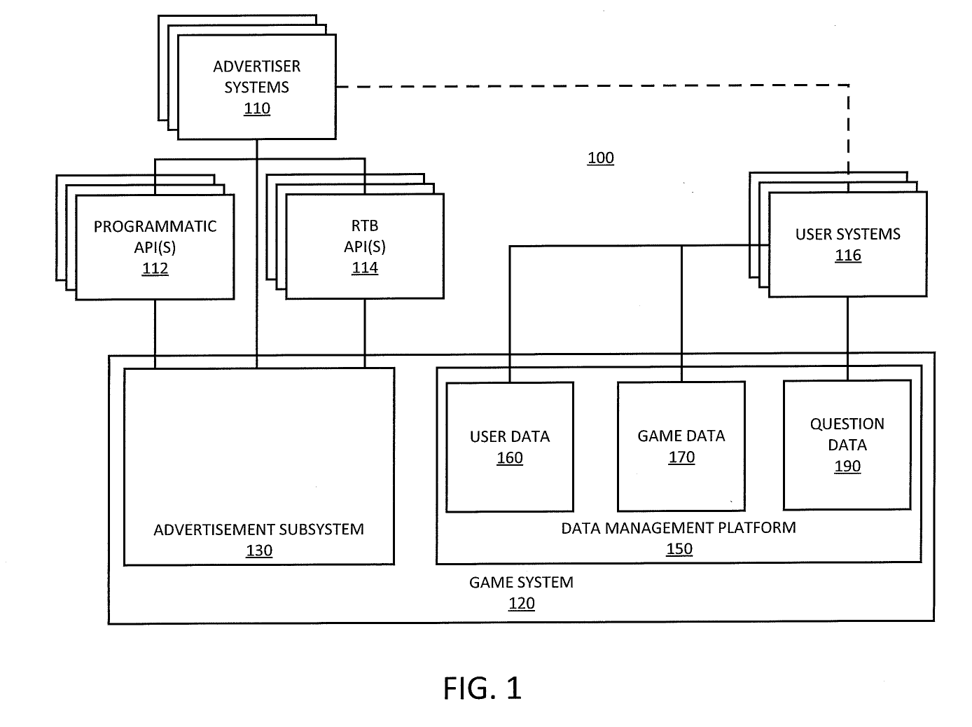

FIG. 1 illustrates a block diagram of an example system of the disclosure;

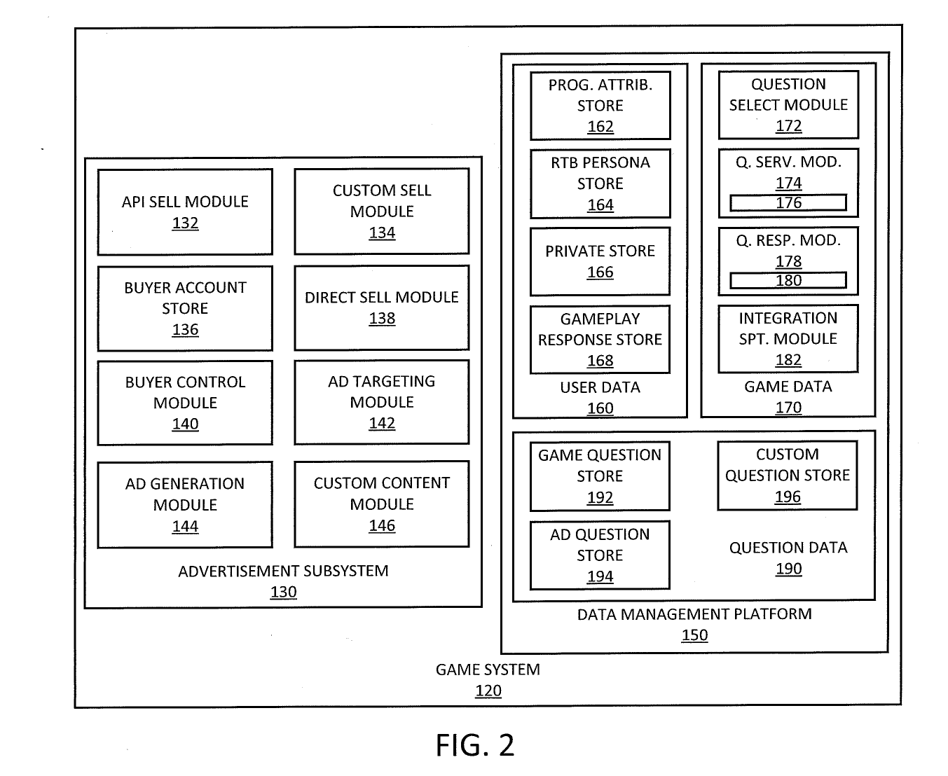

FIG. 2 illustrates a block diagram of an example system of the disclosure;

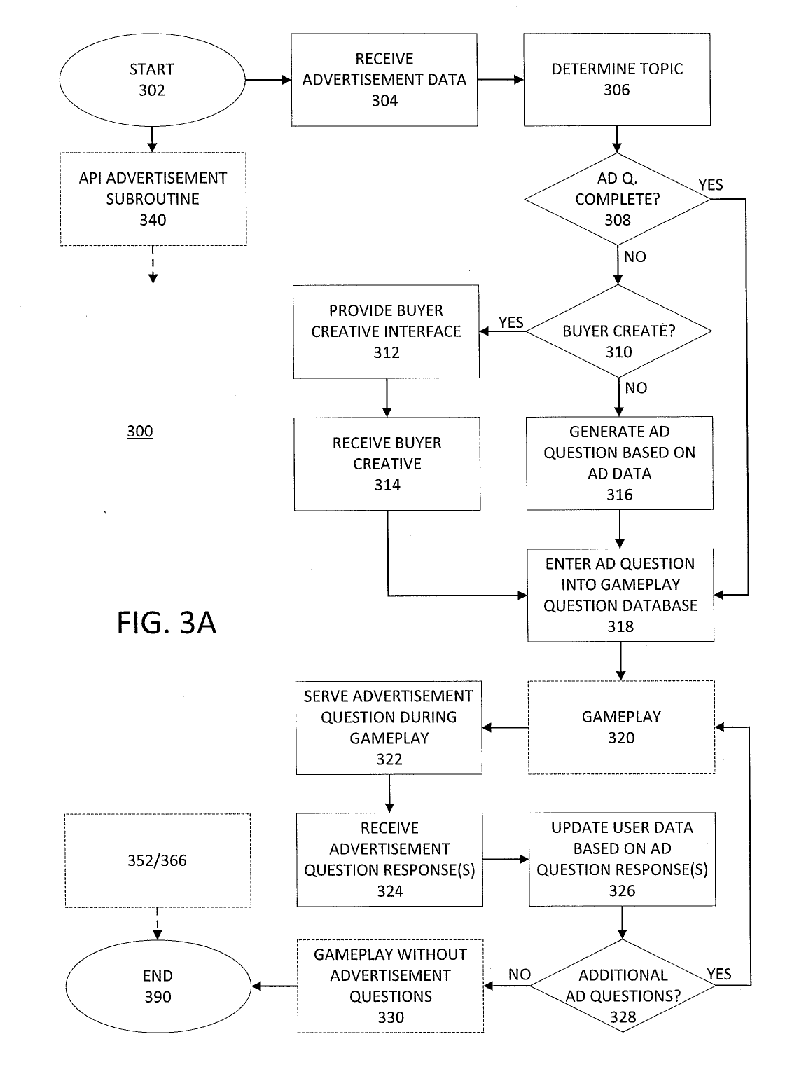

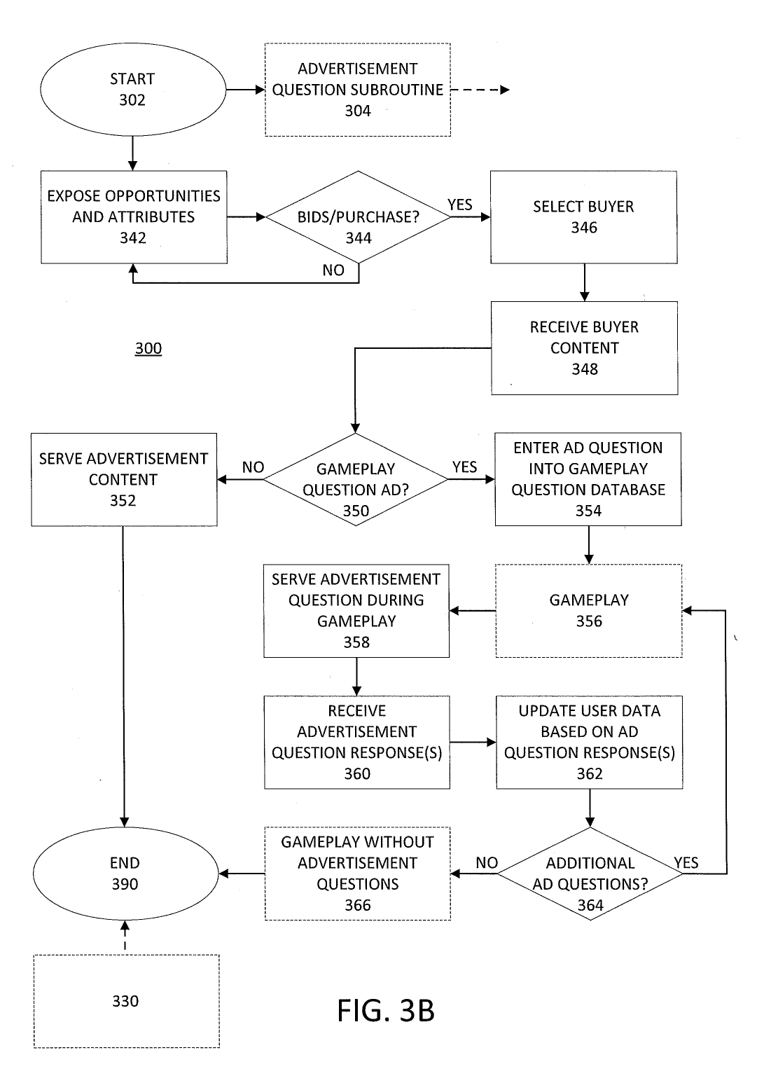

FIGS. 3A and 3B illustrate a flow chart of an example methodology according to the disclosure;

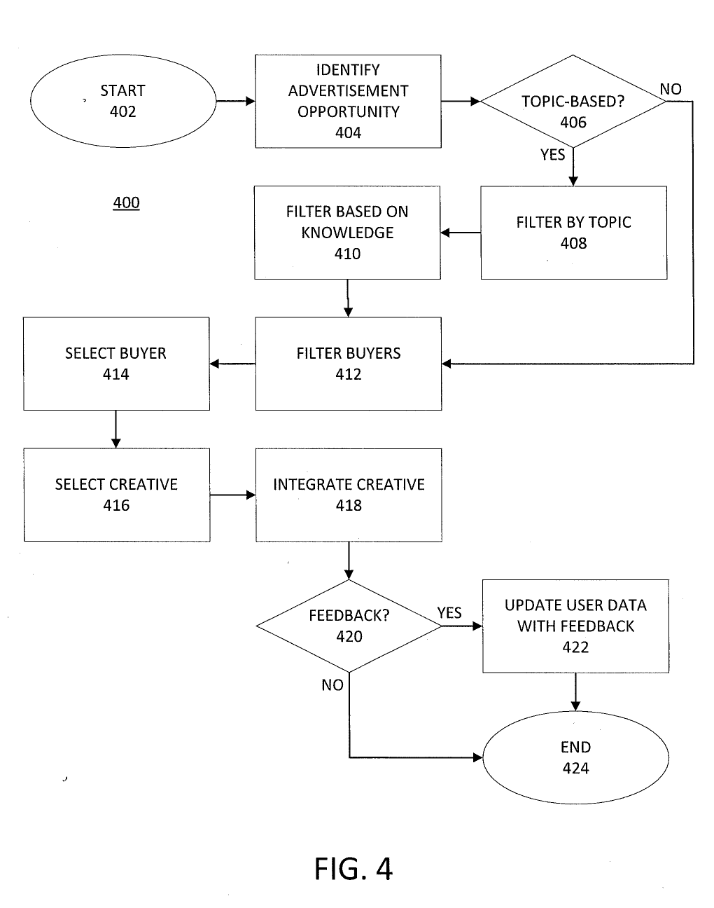

FIG. 4 illustrates a flow chart of another example methodology according to the disclosure;

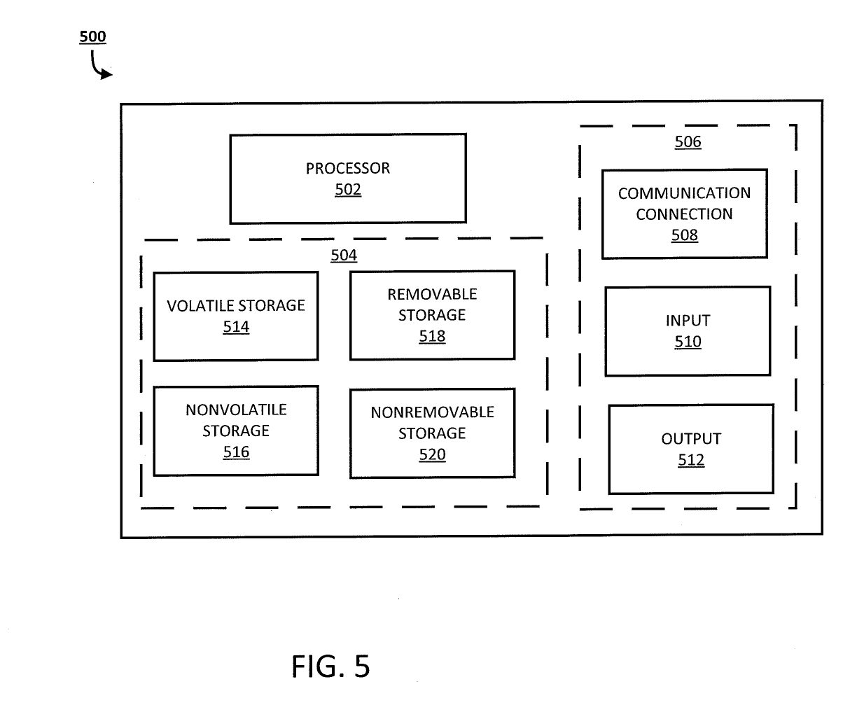

FIG. 5 illustrates an example device used in accordance with the disclosure; and

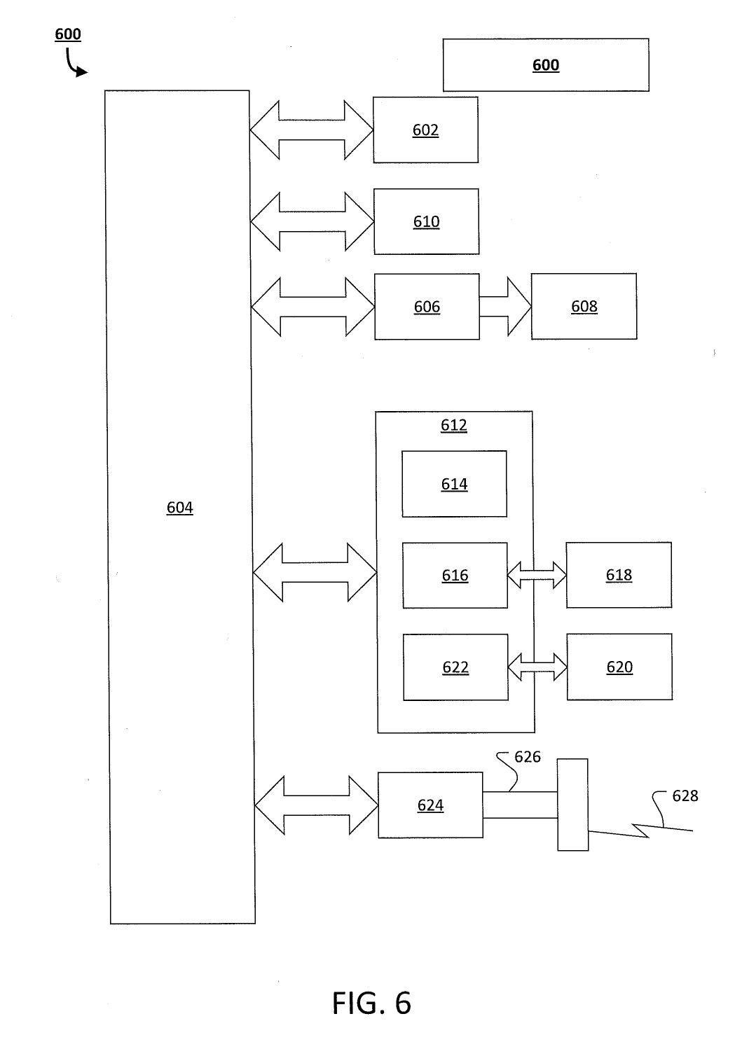

FIG. 6 illustrates an example system used in accordance with the disclosure.

### DETAILED DESCRIPTION

The disclosure generally pertains to a gaming system capable of providing advertising during gameplay in a non-disruptive manner, and providing advertising, marketing, or other sponsored material as content within gameplay. In embodiments, player knowledge can be used in targeting the advertisements. Because gameplay includes providing responses to questions, gameplay questions incorporating or related to advertising, marketing, or other sponsored content can be used to discern individual players' knowledge on particular topics. By determining the presence or absence of a player's knowledge score, and what a player's knowledge score is where one is developed, more effective targeting and advertising can be used during gameplay to deepen existing relationships and specifically select new relationship prospects. This allows advertisers to target parties who do not know about their products, services, or a particular market. In embodiments, advertisers can source “bi-state” or “poly-state” answers from their advertising targets, either indicating the presence or absence of knowledge regarding the advertising topic, and providing a baseline from which to measure future interactions. This can be done while keeping a user in the app or game system, and avoiding their redirection, distraction, or disregard of advertisements. Other advertisement types, such as those integrated through programmatic or Real-Time Bidding techniques can also be integrated. Ongoing relationships through periods of gameplay can provide greater depth for targeting as opposed to one-time surveys or limited web histories and attributes which only record topic consumption but not topic knowledge.

As used herein, a “creative” or “ad unit” can include a portion of content, which can include but is not limited to text, images, video, sound, code, form submissions, instructions, or other data which can be sensed or cause an effect to be sensed by an audience. A creative/ad unit can, but need not be, provided by an advertiser, content sponsor, or other party requesting or purchasing to integrate content into a system such as one described herein.

As used herein, a “knowledge score” is a score associated with a user or group of users indicating the knowledge of the user or group of users with respect to a particular topic (or topics). Knowledge scores can be positive or negative or zero, and may exist or not exist. A “neutral” knowledge score may indicate no score, a score indicating awareness but without a strong opinion, or a score indicating awareness but no depth of knowledge. Where no knowledge score exists, user knowledge has not been tested, or records indicate no confirmed knowledge, of the topic.

Knowledge scores can be implemented as value pairs. In embodiments, the value pairs can indicate instances or responses indicating correct knowledge in a first value of the pair, and instances or responses indicating incorrect knowledge in a second value of the pair. Thus, where a respondent answered five questions on a topic with one correct answer, the pair may be represented as (1:4).

In embodiments, a knowledge score group of more than two values, or a separate value distinct from the knowledge score, can be used to indicate an interest level in a topic. The amount of play, and particularly active participation seeking certain topics, can allow generating and updating of an interest score within or related to the knowledge score for a topic. The interest score can be absolute (e.g., total times exposed) or relative (e.g., percentage of questions related to topic), and can relate to active participation (e.g., user requested) or total incidence (e.g., including times when user did not expressly request topic). Separate from the interest level, either included in a knowledge score group or separate value, an intent level can also be developed. The intent level can be based on responses where there is not a correct or incorrect question, but an opinion or intent is expressed. These can be, e.g., scenario-based or hypothetical questions, or questions soliciting opinions or preferences. Intent questions regarding topics can be characterized or flagged as intent-developing questions, and may or may not contribute to knowledge scores depending on whether any objectively correct or incorrect information can be tested. Intent levels can be quantified based on positive/preferred or negative/avoided responses, either as absolute values, values relative to the total number of questions relating to the topic and involving intent, percentages of questions relating to one or more topics, et cetera. Where interest levels or intent levels are included in knowledge score groups, they may be represented in the form of, e.g., (1:4:5) (e.g., where interest level or intent level is 5) or (1:4:5:3) (e.g., where one of interest level or intent level is 5 and the other is 3).

Knowledge scores may also be implemented in alternative embodiments as a single-value composite. Where knowledge scores exist, their calculation can be based on adding, averaging, differentials between types of responses, et cetera. In one example, a knowledge score based on one correct response and one incorrect response with respect to the same topic will result in a knowledge score of zero.

In embodiments, knowledge scores or knowledge score pairs/groups can range from negative ten to ten or any other value. In embodiments, factors influencing knowledge scores can be scaled or weighted, and so knowledge score inputs need not all be of equal value or have one-to-one value. The weight of an individual knowledge score input can be reduced over time to calculate knowledge scores based on most recent knowledge or allow a cumulative knowledge score to build without changing significantly based on a small number of correct or incorrect answers. Where knowledge scores are based on gameplay responses, “correctness” can indicate objectively correct answers (e.g., selecting “two” when asked the sum of one and one) or may be based on subjective opinions or desired responses from a party interested in the topic. Topics can include particular products or services, particular areas of interest or hobbies, particular brands, competitor brands, industries, et cetera. In embodiments a knowledge score can be an area of study or academic subject, such as medieval history or geometry. Individual parties can have multiple knowledge scores representing knowledge of multiple topics. Knowledge scores as to different topics can have different scoring criteria or scales. In embodiments, knowledge scores among particular groups can be consolidated to provide combined knowledge scores. In embodiments, knowledge scores can be whole numbers, include decimals or fractions, or can have a coordinate value. In embodiments, one or more knowledge scores can be provided as a point or vector in multi-dimensional space (e.g., three or more dimensions).

As used herein, a communication or content portion which is “non-disruptive” or presented “non-disruptively” is one which does not interrupt the flow of gameplay. This includes, but is not limited to, communications or content which do not overlay important portions of screen real estate; which do not slow user response; which do not pause or slow game activity; which do not manifest during timed portions of gameplay; or which are integrated as part of the gameplay (e.g., a question including sponsored content which is provided in the same manner as gameplay questions for a trivia game). Further, as advertisements, marketing materials, or other sponsored content encourage further interaction or follow-up, non-disruptive action can include delaying notifications or transmitting notifications to an account or queue which does not trigger an alert or cause other disruption during gameplay, even if the user explicitly requests follow-up or further action during gameplay (e.g., clicking an advertisement or button to request more information). Non-disruptive communication can still use traditional means, either in real-time or on delay, including but not limited to sending e-mails, providing in-app notifications, transmitting a voice call or text message, downloading or installing data or an application, and others. In embodiments, communication can be made non-disruptive by suppressing notifications from non-gameplay applications or services during gameplay (e.g., blocking e-mail or text message notifications). In embodiments, notifications can be based on conditions in gameplay. In alternative or complementary embodiments, notifications can be based on location, time, or other contextual factors related to the user.

FIG. 1 illustrates an embodiment aspects of a system 100 for implementing aspects disclosed herein. System 100 includes advertiser systems 110, game system 120, and user systems 116. These systems can be implemented as server and/or client systems, either as specialized devices or multipurpose devices, groups of devices, as or in a cloud environment, et cetera.

Advertiser systems 100 can include systems utilized by advertisers to identify advertising channels, target advertisements to parties, purchase advertisements in channels, and provide the advertisements to or through those channels. As shown, advertiser systems may communicate directly with game system 120 or may do so through various interfaces. Interfaces can include Application Programming Interfaces (APIs).

Programmatic API(s) 112 are one such interface type. Programmatic advertisement sales are driven by identification of desired attributes associated with users or audiences. Programmatic API(s) 112 can expose logs of user activity or other data to allow advertisers to observe attributes of audiences for which they may wish to buy advertisements. Programmatic API(s) 112 facilitate(s) this interaction by providing data to advertisers and receiving back requests for purchases and/or advertisement data. Programmatic API(s) 112 may be implemented within game system 120, by advertiser systems 110, and/or at locations physically or logically remote thereto. Programmatic API(s) 112 may be operated or managed by an operator or manager of game system 120, operators or managers of advertiser systems 110, and/or third parties. Programmatic API(s) 112 can sell known advertisement inventory in advance of prospective integration in embodiments, and may be based on a number of exposures or deliveries in a particular context or to users sharing particular attributes.

Real-Time Bidding (RTB) API(s) 114 can be another such interface type. In RTB advertising, a user persona is built based on observable user history. Using low-latency communication channels, personas are offered using RTB API(s) 114 and bids are received from advertiser systems 110 based on their interest in a persona. RTB bidding can be run as an auction in real-time. This allows some behavioral targeting and considers contextual relevance, but does not allow for discovery of all information desired by advertisers, such as topical knowledge of the user associated with the exposed persona. RTB API(s) 114 may be implemented within game system 120, by advertiser systems 110, and/or at locations physically or logically remote thereto. RTB API(s) 114 may be operated or managed by an operator or manager of game system 120, operators or managers of advertiser systems 110, and/or third parties.

Alternatively or complementarily, advertiser systems 110 interact with game system 120 directly or through interfaces in advertisement subsystem 130. This allows alternative techniques for purchasing advertisements (or other content) and facilitates provisioning data alternative to that provided through programmatic API(s) 112 and/or RTB API(s) 114.

User systems 116 are systems associated with players, viewers, or other parties involved with game system 120. User systems 116 can include shared or personally owned mobile devices such as cellular telephones or smartphones, tablets, laptop or desktop personal computers, and other devices or systems capable of providing information from game system 120 to users and receiving information from users. In embodiments, not all users need be provided with the capability to provide input (e.g., where spectators or other non-participants watch gameplay).

Game system 120 includes an advertisement subsystem 130 for managing advertisements and a data management platform (DMP) 150 which includes a user data module 160, a game data module 170, and a question data module 190.

FIG. 2 illustrates game system 120 in greater detail, including some aspects included in embodiments.

Advertisement subsystem 130 is configured to receive offers for advertisements from advertiser systems 110 (directly or via programmatic API(s) 112 and/or RTB API(s) 114). With these offers, advertising subsystem 130 receives advertisement data related to accepted offers for advertisements. Advertisement data includes, but is not limited to, content or information (which may be formatted for integration in game system 120 or require re-formatting) to be integrated as advertisement, either standalone or as game questions.

In embodiments, advertisement subsystem 130 can include a variety of modules, including but not limited to API sell module 132, custom sell module 134, buyer account store 136, direct sell module 138, buyer control module 140, advertisement targeting module 142, advertisement generation module 144, and custom content module 146.

API sell module 132 can interact with APIs including, but not limited to, programmatic API(s) 112 and/or RTB API(s) 114 to receive offers for or purchases of in-game advertisements. In embodiments, API sell module 132 sells advertisements which may be dynamic and/or targeted but are not integrated in gameplay questions.

Custom sell module 134 sells custom advertisements, including, but not limited to, gameplay advertisement questions. Using custom sell module 134, advertiser systems 110 can purchase questions having custom content tailored into gameplay. Custom sell module 134 can interoperate with buyer control module 140 and custom content module 148 to allow advertisers to create and deploy custom sponsored content for users of game system 120.

Direct sell module 138 sells advertisements (which can include, but are not necessarily exclusively, non-custom advertisements) directly to advertiser systems 110, thereby obviating the need for APIs, which may be operated by or licensed from third parties. In embodiments, game system 120 includes API-based and direct-sale based modules for different types of advertisement sales, thereby increasing the number of opportunities and parties with which game system 120 can interoperate, and without excluding either API-based purchasers or direct purchasers which may allow an owner of game system 120 to retain more of the value associated with advertisement sales.

As discussed above, one or more of API sell module 132, custom sell module 134, direct sell module 138, and/or other modules herein, may expose data from DMP 150, including but not limited to user data or portions of user data, to advertisers to provide information regarding advertisements they may wish to purchase or have already purchase.

Buyer account store 136 maintains records of advertisement (or other sponsored content) buyers. This can include, but is not limited to, logins and passwords, payment information, preferred channels, purchase history, authorization, associated advertisement data, et cetera. In embodiments, individual or aggregated data providing feedback from advertisements can be associated with a buyer record of buyer account store 136. Buyer account store 136 can be used to authenticate buyers prior to purchasing or integrating advertisements, as well as provide access to functionality or data of game system 120.

Buyer control module 140 allows advertiser systems 110 or other entities seeking to buy advertisement control over various aspects of their buyer account and/or their advertisements. In embodiments, advertisers can create a buyer account using buyer control module. Balances, payments, bids, pre-ordered advertisement buys, advertisement buy volumes, and other aspects can be viewed, completed, and/or managed using buyer control module 140.

Advertisement purchases can be made or cancelled using buyer control module 140. In embodiments, advertisers can activate or deactivate general or specific campaigns using buyer control module. In embodiments, advertisers can select audiences or targeting, or identify target criteria (e.g., attributes, personas, topics, knowledge scores) using buyer control module. In embodiments, buyer control module 140 can interoperate with custom content module 146 to manage the creation and deployment of custom sponsored content such as gameplay advertisement questions. Account information and other options can also be managed with buyer control module 140.

Advertisement targeting module 142 is configured to assist with targeting advertisements to particular players or users. In embodiments, advertisement targeting module 142 is configured to receive target knowledge information associated with the advertisement data. Target knowledge information can be included in or with advertising data received from advertiser systems 110. Target knowledge information can relate to the presence or absence of a knowledge score associated with a target user or user(s). If the target knowledge information is present, specific values or ranges for the knowledge score can be targeted. In an embodiment, parties with no knowledge score as to a particular topic can be targeted. In an embodiment, parties with a knowledge score as to a particular topic can be targeted. In an embodiments, parties with a specific knowledge score or scores (e.g., positive, negative, between two values, over a certain value, under a certain value, within a range of a particular value, exactly a particular value) can be targeted.

For example, a knowledge score as to a topic can be defined between negative ten and positive ten, where negative ten indicates a party knows only incorrect information about the topic which was substantially polled, zero indicates the party has evenly mixed correct and incorrect responses, and positive ten indicates the party knows significantly more than the average person and is consistently correct as to question topics. The absence of a knowledge score indicates a lack of data, or insufficient data, to calculate a knowledge score as to the topic. Thus, advertisers may seek to target users with scores between negative five and negative ten; with scores of positive 5, plus or minus two; with scores above 3; with scores below zero; with scores of zero; et cetera. Other values can be selected, and a knowledge score as to a particular topic can be calculated or provided over any range of positive or negative values.

While aspects herein discuss “topics,” alternative markers can be used. For example, in embodiments, instead of topics, “keywords” or “phrases” can be used. Keywords or phrases can be measured by incidence or by particular types of activity in relation to the keyword or phrase (e.g., appearance, selection, typing, speaking, et cetera).

In alternative or complementary embodiments, advertisement targeting module 142 can be used with one or more of API sell module 132, custom sell module 134, and/or direct sell module 138 to facilitate targeting with these modules. For example, advertisement targeting module 142 may facilitate exposing data from DMP 150 to advertiser systems 110, and/or interrogating data in DMP 150 for matches to criteria provided by advertiser systems 110, such that advertisements or content purchased through API sell module 132, custom sell module 134, and/or direct sell module 138 can be directed to the advertiser's desired audience. This can include, but is not limited to, providing or interrogating knowledge scores, demographics, user interests, gameplay history, advertisement history, et cetera. In some embodiments, gameplay response data for non-gameplay advertisements can be commingled with other user data for targeting.

Advertisement generation module 144 can be used to generate advertisements based on advertisement data in situations where advertisement data from advertiser systems 110 is not formatted or provided in an appropriate format for integration in gameplay. This can be done through natural language analysis, machine learning, scraping or transforming advertising data provided, supplementing advertising data with local or remote database information, et cetera.

Custom content module 146 can provide an interface or other controls for creating custom sponsored content including gameplay advertisement questions to advertiser systems 110 or entities buying advertisements or sponsored content. In embodiments, custom content module 146 can interoperate with buyer control module 140 to enable development of advertisements or advertising campaigns including custom content.

Custom content module 146 can include a variety of selectable or free-input fields for the development of custom sponsored content including gameplay advertisement questions. Selectable fields can include drop-down menus, radio buttons, checkbox menus, and others which include required, standardized, or commonly-used custom advertisement attributes. Free-input fields can include written text, or opportunities to create or upload multimedia such as file upload interfaces, camera interfaces, microphone interfaces, et cetera. In embodiments multimedia aspects can be included in selectable packages as well, such as content or programming to play sounds or videos provided by game system 120 and/or provide feedback to a user based on devices available and their capabilities.

Custom content module 146 can facilitate development of advertisement aspects which are presented or not presented. Presented advertisement aspects include images, text, sound, et cetera, which is or is intended to be perceived by a target or user. Non-presented advertisement aspects include metadata, controls, and additional information collected through presentation to or interaction with the user.

Custom content module 146 can allow selection of or automatically detect various metadata related to custom content. The metadata can include, but is not limited to, one or more topics with which the custom content is associated. This can be provided by a user or determined through analysis of words, images, or other advertisement data provided. Other metadata can include exposure time, weight, additional information for gathering, incentives, supplemental content to invoke, order of questions (if provided in a set or in reference to other questions), and so forth.

In an example case, an advertiser can access custom content module 146 and select aspects indicating a desire to create a trivia question. The advertiser can type the question and one or more answers, which can include answers which are indicated fully correct, partially correct, and/or incorrect. The answers can be selected to be provided in a multiple-choice format, true-false format, matching format, or others, or in a free form manner allowing typed text, speech, images or video, et cetera. The advertiser can select a standard sound to play at the beginning of the question and different standard sounds and videos to play when a user provides a response based on the answer's correctness. The advertiser can select an image related to the question to show or be involved with the question. The advertiser can select this image to be weighted higher than average due to the expected impression of the image, and can indicate the advertisement will be delivered to users with a target knowledge in a desired range.

In a specific example, a car advertiser can develop a series of questions to educate users with negative knowledge or no knowledge about their models. Topics can include cars, vehicles, the advertiser's brand or model names, et cetera. Pictures of their cars can be shown and questions provided for each. Legacy models, which may be more difficult to identify, can be selected for presentation in gameplay questions to users with higher knowledge scores, while current model years, which may be easier to identify, can be selected for presentation in gameplay questions to users with lower knowledge scores. Positive details about car features and affordability can be selected for presentation in gameplay questions to users with negative knowledge scores (indicating a misunderstanding about the vehicles), and details about performance of special models can be selected for presentation in gameplay questions to users with the highest knowledge scores (indicating a high level of brand enthusiasm).

In embodiments, custom content or gameplay question templates can be provided, and users can locally create custom content which is uploaded or otherwise provided after creation using custom content module 146.

In embodiments, custom content module 146 can include a user friendly interface or “wizard” interface which guides advertisers through a step-by-step process to create custom content.

The controls described for custom content in gameplay are for example purposes only, and other forms of control or content creation can be utilized by custom content module 146 without departing from the scope or spirit of the innovation.

Gameplay advertisements or other custom advertisement content capable of developing knowledge scores can be provided directly by advertiser systems 110, produced automatically by advertisement generation module 144, or produced by an advertiser using custom content module 146, buyer control module 140, and/or other modules. In an example, a gameplay advertisement can be a trivia question or group of questions. The questions can be developed to relate to a product, brand, market, industry, et cetera. The user provides a response to these questions—including not responding, skipping, providing an accidental or non-counted response, or providing an incorrect response—and a knowledge score can be developed based on the user action. The trivia question, or other gameplay advertisement or sponsored custom content, can in aesthetic regard match a non-gameplay advertisement or non-sponsored content. Inferences can also be determined by game system 120 (and/or advertiser systems 110) as to user interest or intent based on response behavior, even if such inferences cannot be used directly in knowledge scores or other calculated metrics.

In embodiments, gameplay advertisement questions can be provided in groups. The group can proceed randomly or arbitrarily through the questions, with or without other intervening questions. In an embodiment, “drill down” series of questions can be provided where subsequent questions are based on earlier questions. In embodiments, “drill down” series of questions can include multiple branches, with the branch of questions chosen based on a previous user response. For example, if the user selects a correct response, a first subset of questions may proceed, whereas if the user selects an incorrect response, a second subset of questions may proceed. User answer regardless of correctness can also be considered. For example, if a user is asked “What is your favorite food?” a typed answer may be used to develop an understanding of user preferences, persona, demographics, attributes, et cetera, and a subsequent question can be based on the food type indicated. If a user types “Mexican,” they may be asked their favorite Mexican restaurant, or if a user types “hamburgers,” they may be asked the price range of burgers most frequently purchased.

In embodiments, gameplay advertisement questions can be matched to targets or audiences automatically (e.g., using question selection module 172). In embodiments, matching can be based on solving parametric equations. In embodiments, matching can be based on optimization techniques.

Both custom and non-custom advertisements can include advertisement identifiers and be associated with advertisement campaigns. Data can be collected and generated into advertisement or campaign reports, and can be aggregated according to various aspects including topic, advertiser, industry, user location, system-wide (e.g., all advertisements handled by game system 120) et cetera. Conversions, advertising actions (e.g., actions taken in response to an interaction with an advertisement) and ongoing interaction based on advertisements can be tracked. Various tags and statistics can be applied or developed based on advertisement creation, delivery, and feedback. Example tags can identify context, users, relevant reports, et cetera. In embodiments, advertisement data and/or related reports can be published publicly. In embodiments, such publication can occur on a blockchain or using other consistent and inspectable techniques, thereby demonstrating system integrity to advertisers and allowing them to audit the platform at any time.

While custom advertisements or question advertisements disclosed herein are described in “gameplay,” other networked environments (e.g., non-gameplay webpage) can utilize aspects of the disclosure without departing from the scope or spirit of the innovation.

DMP 150 stores data related gameplay and players in game system 120. DMP 150 includes user data module 160, game data module 170, and question data module 190.

User data module 160 includes various stores, or fields within stores, for storing data related to players and/or other users of game system 120. In the illustrated embodiment, user data module 160 includes programmatic attribute store 162, RTB persona store 164, private store 166, and gameplay response store 168. In alternative embodiments, one or more stores illustrated may be excluded, and/or one or more stores may be combined as portions of combined stores or fields within combined stores.

Programmatic attribute store 162 stores standard or non-standard attributes associated with users for programmatic advertisement purchases. In an embodiment, 28 (or more, or fewer) standard attributes are included. Standard attributes can provide greater interoperability with non-proprietary APIs. In an embodiment, one or more non-standard attributes are included for use with direct sales or APIs capable of utilizing such attributes.

RTB persona store 164 stores user personas for use with RTB advertisement purchases. In embodiments, personas are shielded from information identifying the party with which the persona is associated. Personas can include a variety of behavioral information including but not limited to internet activity (e.g., e-commerce purchases, browsing history, forum participation, app use, device identification, device location, et cetera). In embodiments, multiple devices can be mapped to a single persona. The personas can be exposed via RTB or direct sale APIs to allow bidding or other targeting of personas for advertisements.

Private store 166 is configured to store confidential user data and is not exposed to advertisers or third parties. Private store 166 can store personally identifiable information (PII) in embodiments. Private store 166 may also maintain account information including information on balances (e.g., credited winnings or paid entry fees for gameplay tournaments) and other information which may be sensitive even if not directly identified as owing to a specific player. In embodiments, private store 166 may use unique identifiers, alone or in combination with additional security such as encryption, to allow recognition of players as individuals (e.g., for knowledge-based targeting purposes) without making any real-world identification of the individual player, and/or to allow the player or game system 120 to perform follow-up actions (e.g., where the user clicks an advertisement or asks for more information) without exposing player identity. In alternative embodiments, some aspects of player identity (e.g., username, account number to remit payment, address to send promotion) can be conditionally exposed (e.g., at player request, based on gameplay) while some aspects (e.g., user payment information, user phone number) are shielded or kept from disclosure outside game system 120.

Gameplay response store 168 stores data related to gameplay responses. Gameplay responses related to gameplay questions both unrelated and related to advertisement data are stored to develop details pertinent to players. Such details can, but need not be, developed statistically. In embodiments, knowledge scores related to topics are maintained in gameplay response store 168. Both advertisement-related and advertisement-unrelated question responses are stored and can be arranged by topic and/or in lists (or other data structures) to aid in analysis and searching. Question responses can include various attributes or states. Question responses can be a selected response out of two or more choices or provided in free form. Question responses can be indicated correct or incorrect, or scored for questions where non-binary responses are accepted. Question responses can also be neither correct nor incorrect where subjective questions are provided or in other situations. Question histories may also be stored to determine if a player has seen a question more than once, how often a player seeks questions related to certain topics, et cetera.

User data module 160 can store additional information in various embodiments. For example, advertisement exposure histories, demographics, interests, and other details which relate to an individual player but are not personally identifiable may be maintained according to player (or other user) account records in user data module 160. In embodiments, user data module 160 includes geolocation data related to one or more users.

Game data module 170 provides gameplay functionality and handles inputs and outputs from users during gameplay. Specific modules of game data module 170 can include (but are not limited to) question selection module 172, question serving module 174, question response module 178, and integration support module 182.

Question selection module 172 selects questions to provide to gameplay users. Question selection module 172 selects questions from game question store 192, advertisement question store 194, and custom question store 196 based on game rules and input from advertisement targeting module 142. Game rules can be uniform for all players during a given period of play, or may be adaptive based on player skill, history, gameplay mode, nature of gameplay (e.g., individual versus tournament), et cetera. Question selection module 172 selects non-advertisement questions from game question store 192 for a portion of gameplay and advertisement questions from advertisement question store 194 for other portions of gameplay. Custom question store 196 can be selected for questions both containing and excluding advertisement data. In embodiments, question selection module can select questions, or variants of questions (e.g., where for a single question some content is “mobile friendly” and other content is optimized for desktop computing), based on the interface through which a user interacts with game system 120.

Game question store 192 can receive game questions from non-advertisement question databases provided or developed by administrators, managers, or users. In an embodiment, a question generation module can be included in question data module 190 and/or game data module 170 to generate properly-formatted questions.

Questions in game question store 192, advertisement question store 194, and/or custom question store 196 can be written in text and/or include various types of multimedia including audio and video. In embodiments, questions can also be associated with question metadata, applied to individual questions or groups of questions. Question metadata can include but is not limited to relevant topics associated with the question, question weighting or value, question difficulty, et cetera.

Once selected, questions are provided to users by question serving module 174. Question serving module 174 can provide questions (including gameplay advertisements) to one or more users, or groups of users collectively, in various gameplay modes. In embodiments, question serving module 174 can include a serving interaction module 176 which is configured to non-disruptively provide content during gameplay.

Question response module 178 receives gameplay responses from the one or more users. The gameplay responses include gameplay advertisement responses and non-advertisement responses. The question response module 178 interacts with gameplay response store 168 to store the gameplay responses. Question response module 178, gameplay response store 168, and/or other elements may create or update knowledge scores of the one or more players based on the gameplay responses. In embodiments, question response module 178 can include response interaction module 180 which can non-disruptively perform follow-up actions related to a question response or other in-game activity. For example, response interaction module can be configured to engage the player based on an advertisement question response, wherein engaging the player is performed non-disruptively.

Integration support module 182 is configured to provide an advertisement integration element to advertiser systems 110. In embodiments, the integration element may be a portion of code or link to provide content to be embedded, or to provide further information about the integration and/or presentation thereof and reaction thereto. In embodiments, integration support module can also include elements for integrating content outside game system 120, thereby allowing advertisement outside the platform and harmonious integration or targeting with larger campaigns.

In embodiments, DMP 150 can include additional modules to facilitate gameplay or other functionality. In this regard, the illustrated embodiment of system 100 and game system 120 are provided for illustrative purposes, showing aspects of the disclosure, and is not exclusive or limiting with respect to systems utilizing aspects of the disclosure. For example, DMP 150 can facilitate multi-player question-based games, including tournament modes.

DMP 150 and associated modules or stores can perform other functions as well. In embodiments, DMP 150 can facilitate financial or non-financial transactions (e.g., handling subscriptions or entry fees, handling awards for winners, et cetera.) In embodiments, at least a portion of DMP 150 is stored on a blockchain. In some embodiments, the blockchain can include non-confidential user data or game data, and be accessible to one or more third parties.

As will be appreciated, various modules or elements can interact with one another to accomplish the aspects described herein. For example, question serving module 174 can interact with various gameplay modules to provide questions into gameplay; or alternatively an additional question insertion module could be provided in game data module 170 in another embodiment.

One or more of DMP 150 or advertisement subsystem 130 may also include logging related to advertisements served. This can include, but is not limited to, advertisement identifiers, advertisers, date-time groups for each advertisement delivery and/or interaction, internet protocol addresses of viewers, geography of viewers, non-targeted attributes or persona features of audience, length of time viewed, et cetera. In embodiments, this data can be predictively modeled by game system 120 or advertiser systems 110 to aid in targeted advertisement buying.

Turning to FIGS. 3A and 3B, a methodology 300 is shown for providing advertisements in a game system. In particular, FIG. 3A illustrates a subroutine for providing gameplay advertisements, while FIG. 3B illustrates a subroutine for providing API-based advertisements. Other subroutines can be utilized with techniques herein without departing from the scope or spirit of the innovation.

Beginning with FIG. 3A, methodology 300 begins at 302 and proceeds to 304. (If using API-based advertisements, methodology 300 can proceed to 340, shown in broken lines in FIG. 3A and proceeding in FIG. 3B). At 304, advertisement data is received. The advertisement data may or may not be formatted in an appropriate format for an advertisement question.

At 306, a topic related to the advertisement data is determined. This topic is also the topic against which a knowledge score of a user will be searched to determine when a sponsored question is selected and served to a user. Thereafter, at 308, a determination is made as to whether an advertisement question is complete and/or available (e.g., determine whether a properly-formatted question already exists related to the advertisement data).

If the determination at 308 returns negative, a subsequent determination at 310 ascertains whether the buyer will create the advertisement question (e.g., the creative to be provided). If the determination at 310 returns negative, methodology 300 may proceed to 316 where an advertisement question is automatically generated based on the advertisement data provided. Automatic generation can use rules-based formatting and generation, machine learning, or other techniques to identify the content and select proper phraSing, answers, and metadata for a question.

If the determination at 310 returns positive, a buyer creative interface may be provided to an advertisement buyer at 312 to permit the buyer to develop their advertisement question including the question phrasing or presentation, answers, and related metadata. The buyer advertisement question or creative is thereafter received at 314.

If the determination at 308 returns positive, or after 314 or 316, methodology 300 advances to 318 where the advertisement question is entered into a question database or store for use during gameplay. The question database or store includes non-advertisement questions in addition to the advertisement question provided.

At 320, gameplay can proceed using non-advertisement game questions as well as the advertisement question. Questions are served during gameplay. Responses are received and logged. Based on question selection or targeting, at 322, the gameplay advertisement is served during gameplay. Serving of the gameplay advertisement can be performed in a non-disruptive manner. At 324, advertisement question response(s) are received. User data is updated at 326 based on the advertisement question response(s). In embodiments, updated user data can immediately be provided to methodology 300, other subroutines, or advertiser systems to aid in real-time advertisement targeting and question selection. In embodiments, responses can be published to a blockchain or similar data structure to allow game records to be viewed and accessed thereafter.

At 328, a determination is made as to whether additional advertisement questions are present for serving to one or more players. If the determination at 328 returns positive, methodology 300 recycles to 320. If the determination at 328 returns negative, methodology 300 proceeds to 330 where gameplay can continue without advertisement questions. When complete, methodology 300 proceeds to end at 390.

Turning to FIG. 3B, methodology 300 begins at 302 and proceeds to 340 where API-based advertisement purchasing occurs. (If using alternative gameplay question-based advertisements, methodology 300 can proceed to 304, shown in broken lines in FIG. 3B and proceeding in FIG. 3A). While aspects of FIG. 3B may be more or less relevant to programmatic and RTB advertisement sales and delivery, modifications to use these and other techniques will be apparent on review of the disclosures herein.

At 342, advertisement opportunities and/or user attributes are exposed to advertiser systems. The data exposed can be provided from a user data module or other stores.

Gameplay data and additional contextual data can also be exposed. Based on this data, advertisers can determine whether they wish to place advertisements in the game at that time or for that audience.

At 344, a determination is made as to whether advertiser systems have bid on or purchased advertisement opportunities. If the determination at 344 returns negative, methodology 300 recycles to 342. If the determination at 344 returns positive, methodology 300 proceeds to 346 where a buyer is selected. Based on this selection, a transaction can be completed (e.g., instant payment from buyer or modification of buyer balance for invoicing). With the transaction complete, at 348, buyer content can be received.

Based on the content received, at 350 a determination can be made as to whether the content received is intended for a gameplay question. If the determination at 350 returns negative, methodology 300 proceeds to 352 where the advertisement content is served to the user. In embodiments, serving of the advertisement content can be non-disruptive. In embodiments, no determination is made at 350, and methodology 300 proceeds from 348 to 352. Once the advertisement is served at 352, methodology 300 can proceed to end at 390.

If the determination at 350 returns positive, a subroutine for integrating advertisement questions received via API (or similar) purchasing techniques can proceed at 354. At 354, the advertisement question is entered into a gameplay question database. In embodiments, the advertisement can also be generated based on data received at 348 prior to entry into the gameplay database.

At 356, gameplay can occur using non-advertisement game questions as well as the advertisement question. Questions are served during gameplay. Responses are received and logged. Based on question selection or targeting, at 358, the gameplay advertisement is served during gameplay. Serving of the gameplay advertisement can be performed in a non-disruptive manner. At 360, advertisement question response(s) are received. User data is updated at 362 based on the advertisement question response(s). In embodiments, updated user data can immediately be provided to other subroutines or advertiser systems to aid in real-time advertisement targeting and question selection.

At 364, a determination is made as to whether additional advertisement questions are present for serving to one or more players. If the determination at 364 returns positive, methodology 300 recycles to 356. If the determination at 364 returns negative, methodology 300 proceeds to 366 where gameplay can continue without advertisement questions. When complete, methodology 300 proceeds to end at 390.

FIG. 4 illustrates a methodology 400 for question selection in gameplay. While aspects of methodology 400 as shown relate to advertisement questions, non-advertisement questions may also be selected through modification of methodology 400 as will be apparent based on aspects herein. The question selected, and/or topics based thereon, need not exclusively be advertisement questions. Methodology 400 begins at 402 and proceeds to 404 where an opportunity to integrate an advertisement in gameplay is identified. At 406, a determination is made if the advertisement has a topical relevance to particular advertising types.

If the determination at 406 returns positive, methodology 400 proceeds to 408 where advertisements or advertisement buyers are filtered by topic. Thereafter, at 410, the advertisements or buyers can be matched by filtering according to the knowledge level of one or more players related to the opportunity as to the topic.

After 410, or if the determination at 406 returns negative, methodology 400 proceeds to 412 where buyers are filtered (e.g., according to accuracy of match, bid for advertisement, prepaid account, et cetera) and at 414 a buyer is selected. In an embodiment, buyers are filtered based on whether any buyer campaign is active with advertising content, or whether a specific campaign is active with advertising content (e.g., related to a specific game, tournament, topic, et cetera).

At 416, a creative associated with the buyer is selected. The creative can be an advertisement or other sponsored content. At 416, the creative is integrated in gameplay and served to at least one user. Thereafter, at 420, a determination is made as to whether feedback related to the creative was received (e.g., gameplay advertisement response, selected to request more information, et cetera). If the determination at 420 returns positive, at 422 user data associated with the user associated with the feedback can be updated to reflect the feedback. Thereafter, or if the determination at 420 returns negative, methodology 400 ends at 424.

In alternative embodiments, methodology 400 can have a buyer identified at the outset and locate opportunities for integrating an already-purchased advertisement. Other variants of advertisement purchasing, selection, and serving will be appreciated on study of the disclosures herein.

In alternative embodiments, advertisement or sponsored content questions can be presented at a different time than during gameplay. For example, a pre-tournament or post-tournament round of game questions can include advertisements or sponsored content, while advertisements and sponsored content are not included in a tournament. Various other embodiments for segregating non-sponsored and sponsored content in a game can be utilized as well.

FIG. 5 illustrates a device 500. Device 500 may comprise all or a part of modules or components herein. Device 500 may comprise hardware or a combination of hardware and software. The functionality to facilitate telecommunications via a telecommunications network may reside in one or combinations of links, portals, or connections. Device 500 depicted in FIG. 5 may represent or perform functionality of one or more modules or elements herein, or combination of modules or components herein, such as, for example, a component or various components of a game system, advertising subsystem, user device, advertiser system, or any appropriate combination thereof. It is emphasized that the block diagram depicted in FIG. 5 is example and not intended to imply a limitation to a specific implementation or configuration. Thus, device 500 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Device 500 may comprise a processor 502 and a memory 504 coupled to processor 502. Memory 504 may contain executable instructions that, when executed by processor 502, cause processor 502 to effectuate operations associated with aspects herein. As evident from the description herein, device 500 is not to be construed as software per se.

In addition to processor 502 and memory 504, device 500 may include an input/output system 506. Processor 502, memory 504, and input/output system 506 may be coupled together (coupling not shown in FIG. 5) to allow communications there between. Each portion of device 500 may comprise circuitry for performing functions associated with each respective portion. Thus, each portion may comprise hardware, or a combination of hardware and software. Accordingly, each portion of device 500 is not to be construed as software per se. Input/output system 506 may be capable of receiving or providing information from or to a communications device or other network entities configured for telecommunications. For example input/output system 506 may include a wireless communications (e.g., WiFi/2.5G/3G/4G/GPS) card. Input/output system 506 may be capable of receiving or sending video information, audio information, control information, image information, data, or any combination thereof. Input/output system 506 may be capable of transferring information with device 500. In various configurations, input/output system 506 may receive or provide information via any appropriate means, such as, for example, optical means (e.g., infrared), electromagnetic means (e.g., RF, WiFi, Bluetooth®, ZigBee®), acoustic means (e.g., speaker, microphone, ultrasonic receiver, ultrasonic transmitter), or a combination thereof. In an example configuration, input/output system 506 may comprise a WiFi finder, a two-way GPS chipset or equivalent, or the like, or a combination thereof.

Input/output system 506 of device 500 also may contain communication connection 508 that allows device 500 to communicate with other devices, network entities, or the like. Communication connection 508 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 506 also may include an input device 510 such as keyboard, mouse, pen, voice input device, or touch input device. Input/output system 506 may also include an output device 512, such as a display, speakers, or a printer.

Processor 502 may be capable of performing functions associated with telecommunications, such as functions for games or advertisements, as described herein. For example, processor 502 may be capable of, in conjunction with any other portion of device 500, providing custom sponsored content in a game as described herein.

Memory 504 of device 500 may comprise a storage medium having a concrete, tangible, physical structure. As is known, a signal does not have a concrete, tangible, physical structure. Memory 504, as well as any computer-readable storage medium described herein, is not to be construed as a signal. Memory 504, as well as any computer-readable storage medium described herein, is not to be construed as a transient signal. Memory 504, as well as any computer-readable storage medium described herein, is not to be construed as a propagating signal. Memory 504, as well as any computer-readable storage medium described herein, is to be construed as an article of manufacture.

Memory 504 may store any information utilized in conjunction with telecommunications. Depending upon the exact configuration or type of processor, memory 504 may include a volatile storage 514 (such as some types of RAM), a nonvolatile storage 516 (such as ROM, flash memory), or a combination thereof. Memory 504 may include additional storage (e.g., a removable storage 518 or a nonremovable storage 520) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by device 500. Memory 504 may comprise executable instructions that, when executed by processor 502, cause processor 502 to effectuate operations to facilitate gameplay or advertisement delivery.

FIG. 6 illustrates a computer-based system 600 that may constitute or include parts of one or more of aspects of, e.g., systems 100 or 120, or device 500. Computer-based system 600 includes at least one processor, such as a processor 602. Processor 602 may be connected to a communication infrastructure 604, for example, a communications bus, a cross-over bar, a network, or the like. Various software aspects are described in terms of this example computer-based system 600. Upon perusal of the present description, it will become apparent to a person skilled in the relevant art(s) how to implement the present disclosure using other computer systems or architectures.

Computer-based system 600 includes a display interface 606 that forwards graphics, text, or other data from communication infrastructure 604 or from a frame buffer (not shown) for display on a display unit 608.

Computer-based system 600 further includes a main memory 610, such as random access memory (RAM), and may also include a secondary memory 612. Secondary memory 612 may further include, for example, a hard disk drive 614 or a removable storage drive 616, representing a floppy disk drive, a magnetic tape drive, an optical disk drive, etc. Removable storage drive 616 reads from or writes to a removable storage unit 618 in a well-known manner. Removable storage unit 618 may represent a floppy disk, magnetic tape, or an optical disk, and may be read by and written to by removable storage drive 616. As will be appreciated, removable storage unit 618 includes a computer usable storage medium having computer software or data stored therein.

In accordance with various aspects of the present disclosure, secondary memory 612 may include other similar devices for allowing computer programs or other instructions to be loaded into computer-based system 600. Such devices may include, for example, a removable storage unit 620 and an interface 622. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from removable storage unit 620 to computer-based system 600.

Computer-based system 600 may further include communication interface 624. Communication interface 624 may allow software or data to be transferred between computer-based system 600 and external devices. Examples of communication interface 624 include, but may not be limited to a modem, a network interface (such as an Ethernet card), a communications port, a Personal Computer Memory Card International Association (PCMCIA) slot and card, or the like. Software or data transferred via communication interface 624 may be in the form of a number of signals, hereinafter referred to as signals 626, which may be electronic, electromagnetic, optical or other signals capable of being received by communication interface 624. Signals 626 may be provided to communication interface 624 via a communication path (e.g., channel) 628. Communication path 628 carries signals 626 and may be implemented using wire or cable, fiber optics, a telephone line, a cellular link, a radio frequency (RF) link, or other communication channels.

In this document, the terms “computer program medium” and “computer usable medium” are used to generally refer to media such as removable storage drive 616, a hard disk installed in hard disk drive 614, or the like. These computer program products provide software to computer-based system 600. The present disclosure is directed to such computer program products.

Computer programs (also referred to as computer control logic) may be stored in main memory 610 or secondary memory 612. The computer programs may also be received via communication interface 604. Such computer programs, when executed, enable computer-based system 600 to perform the functions consistent with the present disclosure, as discussed herein. In particular, the computer programs, when executed, enable processor 602 to perform the features of the present disclosure. Accordingly, such computer programs represent controllers of computer-based system 600.

In accordance with an aspect of the present disclosure, where the disclosure is implemented using a software, the software may be stored in a computer program product and loaded into computer-based system 600 using removable storage drive 616, hard disk drive 614, or communication interface 624. The control logic (software), when executed by processor 602, causes processor 602 to perform the functions of the present disclosure as described herein.

In another aspect, the present disclosure is implemented primarily in hardware using, for example, hardware components, such as application specific integrated circuits (ASIC). Implementation of the hardware state machine to perform the functions described herein will be apparent to persons skilled in the relevant art(s). In yet another aspect, the present disclosure is implemented using a combination of both the hardware and the software. In another aspect, the present disclosure is implemented using software.

Various aspects disclosed herein are to be taken in the illustrative and explanatory sense, and should in no way be construed as limiting of the present disclosure. All numerical terms, such as, but not limited to, “first” and “second” or any other ordinary or numerical terms, should also be taken only as identifiers, to assist the reader's understanding of the various aspects, variations, components, or modifications of the present disclosure, and may not create any limitations, particularly as to the order, or preference, of any aspect, variation, component or modification relative to, or over, another aspect, variation, component or modification.

It is to be understood that individual features shown or described for one aspect may be combined with individual features shown or described for another aspect. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

The present disclosure is described herein with reference to system architecture, block diagrams, flowchart illustrations of methods, and computer program products according to various aspects of the disclosure. It will be understood that each functional block of the block diagrams and the flowchart illustrations, and combinations of functional blocks in the block diagrams and flowchart illustrations, respectively, can be implemented by computer program instructions.

These software elements may be loaded onto a general-purpose computer, special-purpose computer, or other programmable data processing apparatus to produce a machine, such that the instructions that execute on the computer or other programmable data-processing apparatus create means for implementing the functions specified in the flowchart block or blocks. These computer program instructions may also be stored in a computer-readable memory that can direct a computer or other programmable data-processing apparatus to function in a particular manner, such that the instructions stored in the computer-readable memory produce an article of manufacture including instruction means that implement the function specified in the flowchart block or blocks. The computer program instructions may also be loaded onto a computer or other programmable data-processing apparatus to cause a series of operational steps to be performed on the computer or other programmable apparatus to produce a computer-implemented process, such that the instructions that execute on the computer or other programmable apparatus provide steps for implementing the functions specified in the flowchart block or blocks. In an aspect, the computer program instructions may be executed on any remote-hosted application framework, for example, by a processor associated with a cloud server.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, hypertexts, hyperlinks, web forms, popup windows, prompts, and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

The systems, methods, and computer program products disclosed in conjunction with various aspects of the present disclosure are embodied in systems and methods for facilitating multiple types of communications in systems and networks discussed herein.

While aspects of the present disclosure have been particularly shown and described with reference to the examples above, it will be understood by those skilled in the art that various combinations of the disclosed aspects or additional aspects may be contemplated by the modification of the disclosed machines, systems and methods without departing from the spirit and scope of what is disclosed. Such aspects should be understood to fall within the scope of the present disclosure as determined based upon the claims and any equivalents thereof.

What is claimed is:

1. A method, comprising:
receiving advertisement data from an advertiser, wherein a gameplay advertisement is based on the advertisement data;
entering the gameplay advertisement into an advertisement question store of a question data store, wherein the question data store also includes a game question store;
providing gameplay questions from the question store, wherein the gameplay questions include game questions from the game question store and wherein the gameplay advertisement is among the gameplay questions;
receiving gameplay responses from a player, wherein a gameplay advertisement response is among the gameplay responses, and wherein the gameplay advertisement response indicates knowledge of the player with respect to an advertiser-selected topic; and
storing the gameplay responses from the player in a gameplay response store, wherein the gameplay response store is within a user data store.

2. The method of claim 1, further comprising:
determining the advertisement data includes the gameplay advertisement formatted for entry in the question data store.

3. The method of claim 1, further comprising:
determining the advertisement data does not include the gameplay advertisement formatted for entry in the question data store; and
generating the gameplay advertisement formatted for entry in the question data store based on the advertisement data.

4. The method of claim 1, further comprising:
exposing a portion of the user data store to a real-time bidding advertiser;
receiving an advertisement bid from the real-time bidding advertiser, wherein the advertisement bid is associated with a real-time bidding advertisement, wherein the real-time bidding advertisement is not a gameplay advertisement; and
integrating the real-time bidding advertisement into an interface associated with gameplay.

5. The method of claim 1, further comprising:
exposing at least the gameplay response store to the advertiser; and
targeting the gameplay advertisement based on the gameplay responses in the gameplay response store.

6. The method of claim 1, further comprising:
calculating a knowledge score of the player with respect to the advertiser-selected topic based on the gameplay advertisement response.

7. The method of claim 1, further comprising:
providing an advertising action in response to the gameplay advertisement response, wherein the advertising action is provided in a non-disruptive manner.

8. A method, comprising:
receiving advertisement data from an advertiser, wherein a gameplay advertisement is based on the advertisement data, and wherein the advertisement data includes a target knowledge score;
storing the gameplay advertisement in a question database;
interrogating a user data store to identify one or more users to receive the gameplay advertisement based on the target knowledge score; and
providing the gameplay advertisement to the one or more users.

9. The method of claim 8, further comprising:
receiving gameplay responses from the one or more users, wherein gameplay advertisement responses are among the gameplay responses; and
storing the gameplay responses from the one or more users in a gameplay response store, wherein the gameplay response store is within the user data store.

10. The method of claim 9, further comprising:
creating or updating knowledge scores of the one or more players in the user data store based on the gameplay advertisement responses.

11. The method of claim 8, wherein the target knowledge score indicates negative knowledge of an advertiser-selected topic.

12. The method of claim 8, wherein the target knowledge score indicates neutral knowledge of an advertiser-selected topic.

13. A system, comprising:
an advertising subsystem configured to receive offers for advertisements from advertiser systems, wherein the advertising subsystem receives advertisement data related to accepted offers for advertisements;
an advertisement targeting module of the advertising subsystem configured to receive target knowledge information associated with the advertisement data;
a user data store of a data management platform configured to store user data including user knowledge information associated with one or more users;
a game data store of the data management platform configured to provide question-based gameplay including the advertisement data to the one or more users; and
a question data store of the data management platform including gameplay questions, wherein the gameplay questions include gameplay advertisements based on the advertisement data, and wherein the gameplay advertisements are provided to the one or more users based on the target knowledge information and the knowledge information.

14. The system of claim 13, further comprising:
an advertisement generation module of the advertising subsystem configured to produce the advertisement question from the advertisement data.

15. The system of claim 13, further comprising:
a buyer account store configured to store information related to one or more advertisers.

16. The system of claim 13, further comprising:
a custom content module configured to provide an interface to an advertiser for creating the advertisement question based on the advertisement data.

17. The system of claim 13, further comprising:
a private store of the user data store configured to store confidential user data, wherein the private store is not exposed to advertisers.

18. The system of claim 13, further comprising:
a question selection module of the game data store configured to select questions from the question data store, wherein one or more of the selected questions are based on the target knowledge information and the knowledge information;
a question serving module of the game data store configured to serve the selected questions to a player among the one or more users; and
a question response module configured to receive responses to the selected questions from the player.

19. The system of claim 18, further comprising:
a response interaction module of the question response module configured to engage the player based on an advertisement question response, wherein engaging the player is performed non-disruptively.

20. The system of claim 13, further comprising:
an integration support module of the game data store configured to provide an advertisement integration element to the advertiser systems.
